(19) United States
(12) Patent Application Publication
(10) Pub. No.: US 2015/0165884 A1
(43) Pub. Date: Jun. 18, 2015

(54) DOOR DIVISION CHANNEL FOR A VEHICLE

(71) Applicants: Hyundai Motor Company, Seoul (KR); SEJIN Co., Ltd., Gyeongju-si (KR)

(72) Inventors: Jae Seung Lee, Hwaseong-si (KR); Jong Kook Yoon, Ulsan (KR)

(73) Assignees: Hyundai Motor Company, Seoul (KR); SEJIN Co., Ltd., Gyeongju-si (KR)

(21) Appl. No.: 14/293,968

(22) Filed: Jun. 2, 2014

(30) Foreign Application Priority Data
Dec. 18, 2013 (KR) 10-2013-0158779

(51) Int. Cl. B60J 10/04; B60J 1/00; B60J 1/17; B32B 3/26

(52) U.S. Cl. CPC B60J 10/042; B32B 3/263; B60J 1/007; B60J 1/17; B60J 10/04; B32B 2250/02; B32B 2605/00

(57) ABSTRACT

A door division channel for a vehicle is provided between a sliding glass and a fixed glass of the vehicle to support the respective glasses. The door division channel includes an inner panel and an outer panel which are connected to upper and lower ends of a glass frame to cover a gap between the sliding glass and the fixed glass at the indoor side and the outdoor side of the vehicle, respectively; an inner elongation part of the inner panel elongating to the outer panel through the gap; and an outer elongation part of the outer panel elongating to the inner panel through the gap to couple with the inner elongation part.

### CROSS-REFERENCE TO RELATED APPLICATION

The present application claims priority of Korean Patent Application Number 10-2013-0158779 filed on Dec. 18, 2013, the entire contents of which application are incorporated herein for all purposes by this reference.

### BACKGROUND OF INVENTION

1. Field of Invention

The present invention relates to a door division channel for a vehicle, and more specifically, to a door division channel for a vehicle having a separated structure capable of being easily mounted on the vehicle.

2. Description of Related Art

Commonly, door glasses 10 and 20, in particular, the door glasses 10 and 20 mounted on the rear door for a vehicle include the fixed glass 10 and the sliding glass 20. As shown in FIG. 1, the fixed glass 10 is a part stably fixed to a glass frame 40 enclosing the door glasses 10 and 20 in the rear door of a vehicle. In general, all the edges of the glass frame 40 other than an edge arranged on the sliding glass 20 side are fixed to the glass frame 40 by screwing or fitting to hold the fixed state thereof.

Meanwhile, the sliding glass 20 is a part sliding up and down by an operation of a driver to move in a vertical direction. The edges of the sliding glass 20 are slidably inserted into a glass run channel while maintaining an airtight between the glass frame and the sliding glass 20.

In addition, a door division channel 30 is provided between the sliding glass 20 and the fixed glass 10 to maintain airtight therebetween and support the fixed glass 10.

The door division channel 30 includes a fixed molding arranged on the fixed glass 10 side to enclose the fixed glass 10, and the glass run channel integrally provided on the sliding glass 20 side to maintain airtight between the fixed glass 10 and the sliding glass 20.

As an example of the door division channel 30, Korean Utility Model Laid-Open Publication No. 20-1999-0024558 discloses a “structure of mounting a rear door division channel” in which both of the glass run channel and the fixed molding are integrally coupled or molded in a body from the beginning so as to install together with the fixed glass 10 during mounting. Therefore, as shown in (a) and (b) of FIG. 2, during the process of mounting the door division channel 30 together with the fixed glass 10, the door division channel 30 contacts with the glass frame 40 and the sliding glass 20. Thereby, the mounting operation thereof is significantly inconvenient due to an interference formed therebetween during assembling.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to solve the above-described problems associated with prior art and/or other problems. The present invention is directed to provide a door division channel having a separated structure capable of being easily mounted on the vehicle by providing a plurality of separated parts for easily mounting the door division channel.

In various aspects according to the present invention, there is provided a door division channel for a vehicle provided between a sliding door and a fixed glass of the vehicle to support the respective glasses. The door division channel may include an inner panel and an outer panel which are connected to upper and lower ends of a glass frame to cover a gap between the sliding glass and the fixed glass at an indoor side and an outdoor side of the vehicle, respectively; an inner elongation part of the inner panel elongating to the outer panel through the gap; and an outer elongation part of the outer panel elongating to the inner panel through the gap to couple with the inner elongation part.

The inner elongation part and the outer elongation part may be overlapped in the gap to divide the gap into a fixed glass side space and a sliding glass side space. The inner elongation part and the outer elongation part may be coupled by screws in an overlapped state.

A molding for fixing an inserted edge of the fixed glass facing the sliding glass may be disposed in the fixed glass side space to couple with the inner elongation part or the outer elongation part. A glass run channel may be located in the sliding glass side space. The molding may be integrally with the inner elongation part and the outer elongation part by screws.

According to the door division channel for a vehicle having the above-mentioned configuration, it is possible to easily mount the door division channel having a structure separated into a plurality of panels. In addition, according to the door division channel for a vehicle having the above-mentioned configuration, it is possible to stably support the fixed glass and the sliding glass by the stable coupling with the glass frame.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present invention will now be described in detail with reference to exemplary embodiments thereof illustrating the accompanying drawings which are given herein below by way of illustration only, and thus are not limitative of the present invention, and wherein:

FIG. 1 is a side view for a vehicle showing a structure of a conventional door glass;

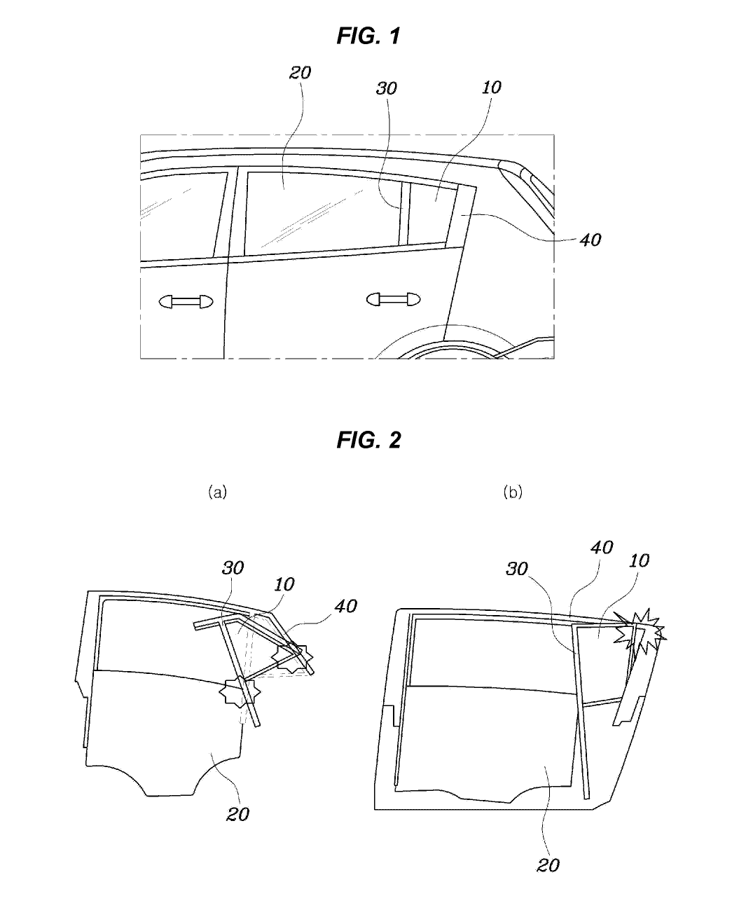

FIG. 2 is a view for explaining problems occurred during mounting the door division channel of a related art;

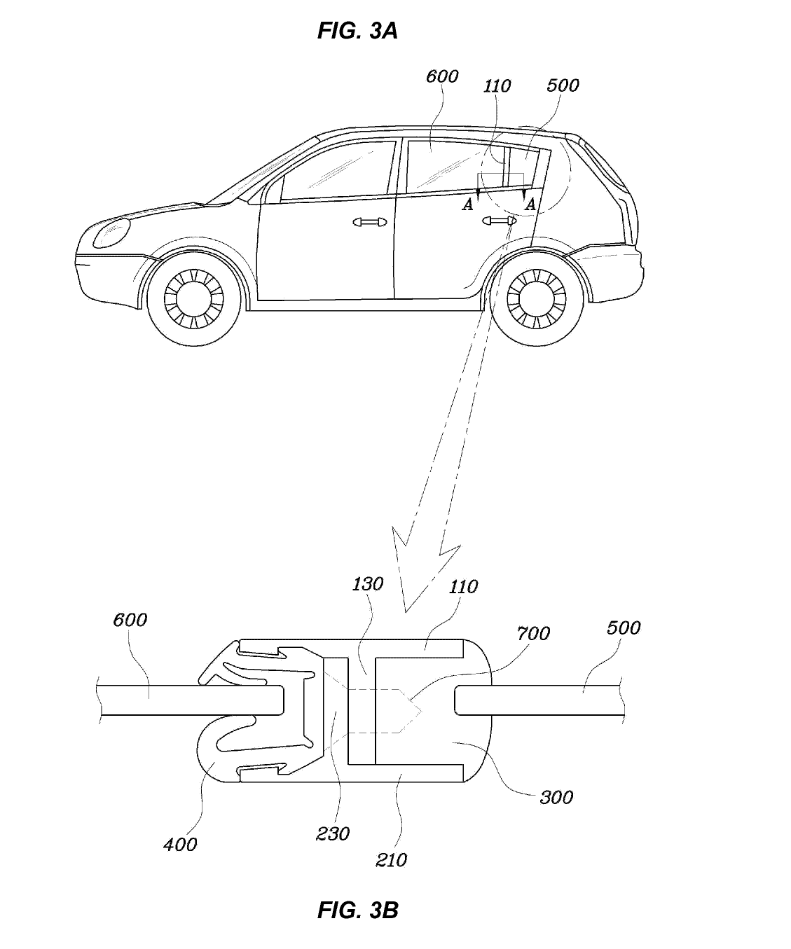

FIG. 3A is a side view of a vehicle including an exemplary door division according to the present invention.

FIG. 3B is a cross-sectional view of the exemplary door division channel shown in FIG. 3A;

FIG. 4, FIG. 5, FIG. 6 and FIG. 7 are views illustrating an exemplary mounting sequence of an exemplary door division channel according to the present invention, respectively.

It should be understood that the appended drawings are not necessarily to scale, presenting a somewhat simplified representation of various features illustrative of the basic principles of the invention.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

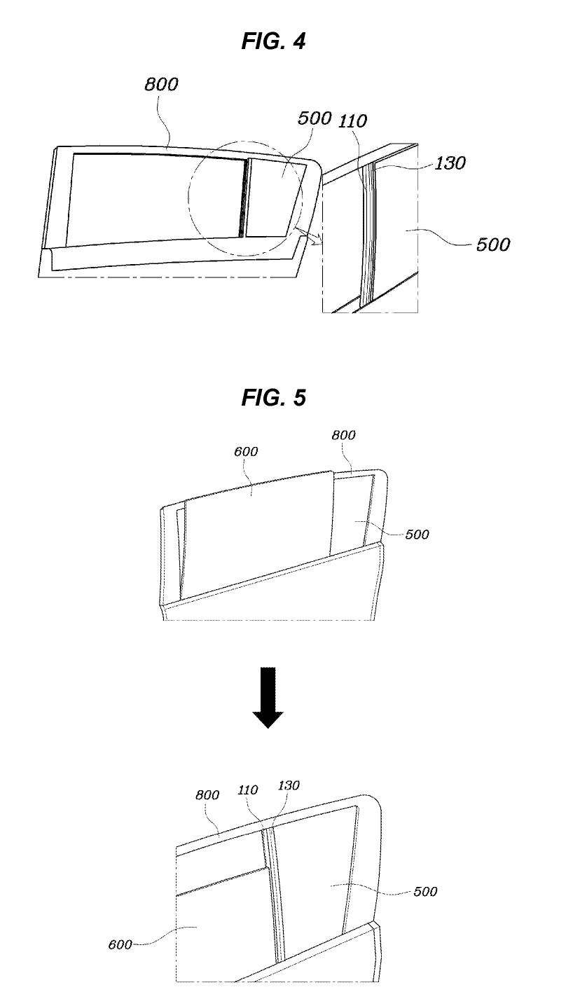

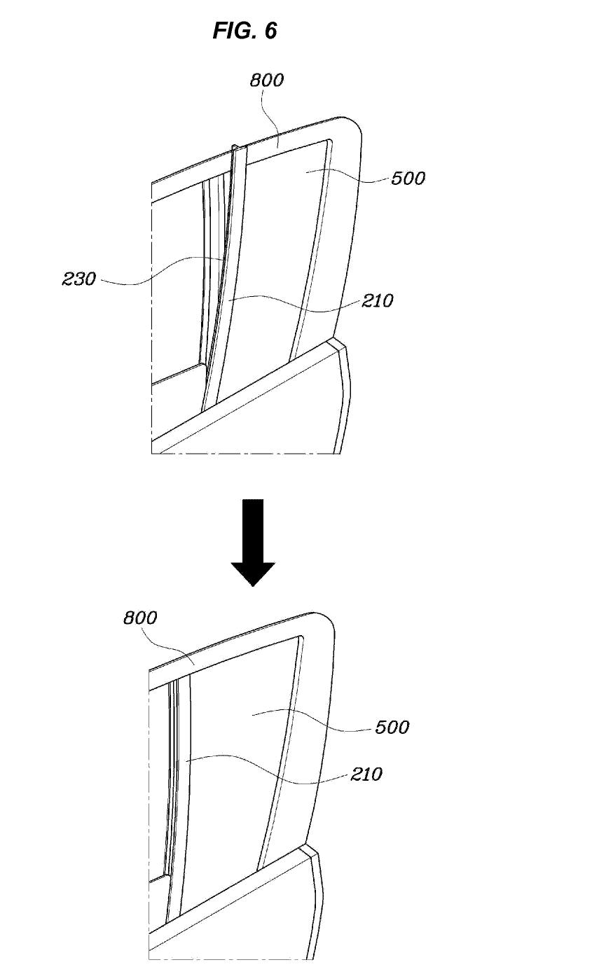

FIG. 3 is the cross-sectional view of a door division channel for a vehicle according to various embodiments of the present invention. The door division channel for a vehicle of the present invention is provided between a sliding glass 600 and a fixed glass 500 of the vehicle to serve as a support for respective glasses. The door division channel includes: an inner panel 210 and an outer panel 110 which are connected to upper and lower ends of the glass frame 800, respectively to cover a gap between the sliding glass 600 and the fixed glass 500 at an indoor side and an outdoor side of the vehicle, respectively; an inner elongation part 230 of the inner panel 210 elongating to the outer panel 110 through the gap; and an outer elongation part 130 of the outer panel 110 elongating to the inner panel 210 through the gap to couple with the inner elongation part 230.

Herein, the sliding door 600 and the fixed glass 500 form a door window glass installed in a front door or a rear door for a vehicle. Specifically, the fixed glass 500 is a glass held in a sate completely fixed to the glass frame 800 enclosing the edge of the door window glass at an upper side of a door frame, and the sliding door 600 is a glass sliding up and down by an operation of a driver to move in a vertical direction. These glasses have a similar structure to the structure mentioned in related art.

More specifically, in the door division channel for a vehicle according to various embodiments of the present invention, the inner panel 210 and the outer panel 110 are panels vertically elongating between the upper and lower ends of the glass frame 800. Both ends of the respective panels may be connected to the upper and lower ends of the glass frame 800. The glass frame 800 may include the door panel located at the lower side thereof.

Preferably, in some embodiments, the inner panel 210 and the outer panel 110 have a width to be able to sufficiently cover a portion of the edges of the fixed glass 500 and the sliding door 600 facing each other.

Meanwhile, in some embodiments, it is preferable that the inner elongation part 230 is formed on a surface of the inner panel 210 facing the outer panel 110 side and the outer elongation part 130 is formed on the surface of the outer panel 110 facing the inner panel 210.

In addition, in some embodiments, it is preferable that the inner elongation part 230 and the outer elongation part 130 are formed in a body with the inner panel 210 and the outer panel 110, respectively, by molding, but it is not particularly limited thereto. For example, the respective elongation parts are molded in separated pieces and then coupled to the inner and outer panels by bonding or welding. Preferably, both elongation parts are made of a metal material such as steel, aluminum or the like.

Meanwhile, in some embodiments, it is preferable that the inner elongation part 230 and the outer elongation part 130 are overlapped in the gap to divide the gap into a fixed glass 500 side space and a sliding glass 600 side space.

Specifically, the inner elongation part 230 and the outer elongation part 130 are formed in a substantially center portion of the inner panel 210 and the outer panel 110, such that the cross section formed by the inner panel 210 and the outer panel 110 and the inner elongation part 230 and the outer elongation part 130 is formed in a “H” shape. Therefore, the fixed glass 500 side space surrounded by the inner panel 210, the outer panel 110, and the inner elongation part 230 or the outer elongation part 130 is formed on the fixed glass 500 side, while the sliding glass 600 side space surrounded by the inner panel 210, the outer panel 110, and the inner elongation part 230 or the outer elongation part 130 is formed on the sliding glass 600 side.

The inner elongation part 230 and the outer elongation part 130 may be located either in the fixed glass 500 side space facing the sliding glass 600 side or in the sliding glass 600 side space facing the fixed glass 500 side in the overlapped state. As an example, the present invention will be described based on the case in which the inner elongation part 230 located in the sliding door 600 side space facing the fixed glass 500 side in the overlapped state,

Meanwhile, a molding 300 for fixing the inserted edge of the fixed glass 500 facing the sliding glass 600 side may be located in the fixed glass 500 side space to couple with the inner elongation part 230 or the outer elongation part 130.

That is, preferably, in some embodiments, the molding 300 is located in the fixed glass 500 side space so as to be supported by the inner panel 210, the outer panel 110, and the outer elongation part 130, and has a groove formed in a surface facing the fixed glass 500 side along a longitudinal direction thereof so as to hold a portion of the edge of the fixed glass 500. The molding 300 may be one that is commonly used in the vehicle, and therefore, a detailed description thereof will be omitted.

Further, a glass run channel 400 is located in the sliding glass 600 side space. The glass run channel 400 is located in the sliding door 600 side space formed by the outer panel 110, inner panel 210, and the inner elongation part 230 for supporting the inserted sliding glass 600 side space. The glass run channel 400 may be one that is also commonly used in the vehicle, and therefore, a detailed description thereof will be omitted.

The molding 300 is integrally fixed to the inner elongation part 230 and the outer elongation part 130 such as by screws 700. During assembling, a worker puts the screw 700 in the inner elongation part 230, the outer elongation part 130, and the molding 300, thereby it is possible to hold the state in which the molding 300 is coupled with the inner elongation part 230 of the inner panel 210 and the outer elongation part 130 of the outer panel 110.

Of course, the glass run channel 400 may be simultaneously coupled to the inner elongation part 230 during the screwing. In this case, it is preferable that the screw 700 is inserted into the glass run channel 400 so as to reach the molding 300.

In addition, the inner elongation part 230 and the outer elongation part 130 may be coupled each other excluding the fixing between the molding 300 and the glass run channel 400. In this case, it is preferable that both the molding 300 and the glass run channel 400 are fitted by inserting.

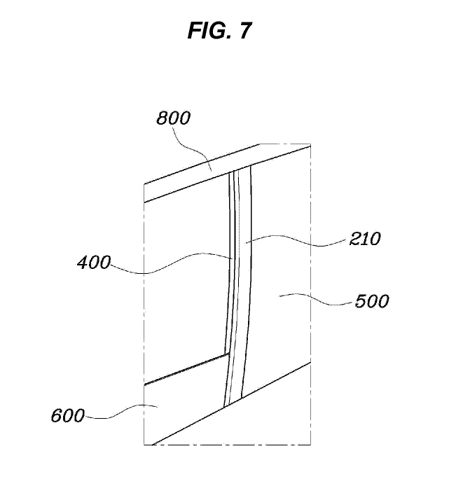

FIGS. 4 to 7 are views for explaining a mounting sequence of the door division channel according to various embodiments of the present invention, respectively. First, FIG. 4 is a perspective showing mounting the fixed glass 500 on the glass frame 800. It is preferable that the fixed glass 500 is mounted on the glass frame 800 in a state in which the outer panel 110 and the outer elongation part 130 are temporarily fixed to the molding 300, before mounting. At this time, both ends of the outer panel 110 may be fixed to upper and lower ends of the glass frame 800.

Next, as shown in FIG. 5, the sliding glass 600 is mounted on the glass frame 800. At this time, it is preferable that the edge of the fixed glass 500 side facing the sliding glass 600 is positioned on the outer panel 110, while maintaining a predetermined gap between the outer panel 110 and the outer elongation part 130. This gap serves as a space to be inserted the glass run channel 400 in a subsequent process.

After mounting the sliding glass 600, the inner elongation part 230 and the inner panel 210 formed in a body are mounted on the glass frame 800. At this time, preferably, the inner elongation part 230 is positioned so as to overlap on the outer elongation part 130, and then a plurality of screws 700 are fastened to the molding 300 from the inner elongation part 230 in the longitudinal direction of the inner elongation part 230, thereby, the fixed glass 500 is supported by the outer panel 110 and the inner panel 210. Of course, both ends of the inner panel 210 are fixed to the upper and lower ends of the glass frame 800.

Thereafter, as shown in FIG. 7, the glass run channel 400 is inserted into a space formed by the sliding glass 600, the outer panel 110, the inner panel 210, and the inner elongation part 230 to be fixed therein, thereby mounting of the door division channel is completed.

According to the door division channel for a vehicle having the above-mentioned configuration, it is possible to easily mount the door division channel by providing the separated structure of the inner panel 210 and the outer panel 110, and it is also possible to stably support the fixed glass 500 and the sliding glass 600 by the stable coupling with the glass frame 800.

For convenience in explanation and accurate definition in the appended claims, the terms “upper” or “lower”, “front” or “rear”, “inner” or “outer”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A door division channel for a vehicle provided between a sliding glass and a fixed glass of the vehicle to support the respective glasses, the door division channel comprising:
an inner panel and an outer panel which are connected to upper and lower ends of a glass frame to cover a gap between the sliding glass and the fixed glass at an indoor side and an outdoor side of the vehicle, respectively;
an inner elongation part of the inner panel elongating to the outer panel through the gap; and
an outer elongation part of the outer panel elongating to the inner panel through the gap to couple with the inner elongation part.

2. The door division channel for a vehicle of claim 1, wherein the inner elongation part and the outer elongation part are overlapped in the gap to divide the gap into a fixed glass side space and a sliding glass side space.

3. The door division channel for a vehicle of claim 2, wherein the inner elongation part and the outer elongation part are coupled by screws in an overlapped state.

4. The door division channel for a vehicle of claim 2, wherein a molding for fixing an inserted edge of the fixed glass that faces the sliding glass is disposed in the fixed glass side space to couple with the inner elongation part or the outer elongation part.

5. The door division channel for a vehicle of claim 2, wherein a glass run channel is located in the sliding glass side space.

6. The door division channel for a vehicle of claim 4, wherein the molding is integrally coupled with the inner elongation part and the outer elongation part by screws.
